(19) United States
(12) Patent Application Publication
(10) Pub. No.: US 2022/0335283 A1
(43) Pub. Date: Oct. 20, 2022

(54) SYSTEMS AND METHODS FOR ACCELERATED NEURAL-NETWORK CONVOLUTION AND TRAINING

(71) Applicant: Rambus Inc., San Jose, CA (US)

(72) Inventors: Steven C. Woo, Saratoga, CA (US); Amogh Agrawal, Wast Lafayette, IN (US)

(21) Appl. No.: 17/845,769

(22) Filed: Jun. 21, 2022

Related U.S. Application Data
(63) Continuation of application No. PCT/US2020/061906, filed on Nov. 24, 2020.
(60) Provisional application No. 62/953,814, filed on Dec. 26, 2019.

(51) Int. Cl. G06N 3/063; G06N 3/08

(52) U.S. Cl. CPC G06N 3/063; G06N 3/084

(57) ABSTRACT

An application-specific integrated circuit for an artificial neural network is integrated with a high-bandwidth memory. The neural network includes a systolic array of interconnected processing elements, including upstream processing elements and downstream processing elements. Each processing element includes input/output port pairs for concurrent forward and back propagation. The processing elements can be used for convolution, in which case the input/output port pairs can support the fast and efficient scanning of kernels relative to activations.

### BACKGROUND

Artificial neural networks are computing systems inspired by biological neural networks (e.g., brains). Artificial neural networks (hereafter just “neural networks”) include interconnected collections of artificial neurons that loosely model their biological counterparts. Like their biological counterparts, artificial neural networks “learn” to perform tasks by the repetitious consideration of examples. To sort fruit, for example, an artificial neural network can be trained to distinguish ripe from unripe samples by considering images that have been manually labeled as “ripe” or “unripe.” Such training adjusts the impact of image data on the artificial neurons and their interconnections. Image properties, such as color and texture, can thus be automatically correlated to probabilities that images represent ripe or unripe fruit, eventually allowing a trained neural network to infer a probability of whether a new, unlabeled image represents a ripe or unripe fruit.

Neural networks are tasked with solving problems much more complex than sorting fruit. For example, neural networks are being adapted for self-driving vehicles, natural-language processing, and a host of biomedical applications like diagnostic image analysis and drug design. Neural networks charged with addressing these problems can be fantastically complex, possibly having millions of connected neurons. In image processing, for example, some layers of neurons serve as convolutional filters, others pool the results from convolution layers, and still others sort the pooled results. Whatever the function, each neuron requires fast access to storage for values settled upon in training and used for inference. Training and inference thus require access to high-performance memory.

### BRIEF DESCRIPTION OF THE DRAWINGS

The present disclosure is illustrated by way of example, and not by way of limitation, in the figures of the accompanying drawings. For elements with numerical designations the first digit indicates the figure in which the element is introduced, and like references refer to similar elements within and between figures.

FIG. 1 illustrates an application-specific integrated circuit (ASIC) 100 for an artificial neural network with an architecture that minimizes connection distances between processing elements and memory (e.g. stacked memory dies), and thus improves efficiency and performance.

FIG. 2 illustrates four processing tiles 120 interconnected to support concurrent forward and back propagation.

FIG. 3 includes a functional representation 300 and an array 305 of a neural network instantiated on a single processing tile 120.

FIG. 4 depicts a processing element 400, an example of circuitry suitable for use as each processing element 320 of FIG. 3.

FIG. 5A through 5H each depict array 305 of FIG. 3 during a respective systolic processing cycle as outputs O1, O2, and O3 are applied to successive processing elements 320.

FIG. 6 includes a functional representation 600 and a systolic array 605 of a neural network instantiated across two dissimilar processing tiles.

FIG. 7 depicts a 3D-IC 700 that instantiates the array of a tile 120 and array 610 of the neural network depicted in FIG. 6.

FIG. 8A depicts processing element 400 of FIG. 4 with circuit elements provided in support of back propagation highlighted using bold line widths.

FIG. 8B depicts a processing element 800 similar to processing element 400 of FIGS. 4 and 8A, with like-identified elements being the same or similar.

FIGS. 9A-9H illustrate information flow during back propagation through processing tile 120 and array 610 interconnected in the manner illustrated in FIG. 7.

FIG. 10 depicts a die stack 1000 as an artificial neural network application in accordance with another embodiment.

FIG. 11 depicts a 3D-IC 1100 that instantiates a CNN using a pair of physically and electrically interconnected IC dies 1105, each of which includes a systolic array of convolutional processing elements (CPEs) 1110.

FIGS. 12A-12F include simplified views of 3D-IC 1100 of FIG. 11 showing each IC die 1105 as a systolic three-by-three array in which each element is a CPE 1110.

FIG. 13 depicts four instances of a tile 1300 with forward-propagation input switches 1305 and back-propagation input switches 1310 that together support the connectivity and related signal flow detailed above in connection with FIGS. 12A-12F.

FIGS. 14A-14D depicts a device architecture 1400 in which four processing tiles 1300 can be interconnected by switches 1305 and 1310 to implement a systolic array for a convolutional neural-network, or for a network of processing elements of the type detailed in FIG. 3.

### DETAILED DESCRIPTION

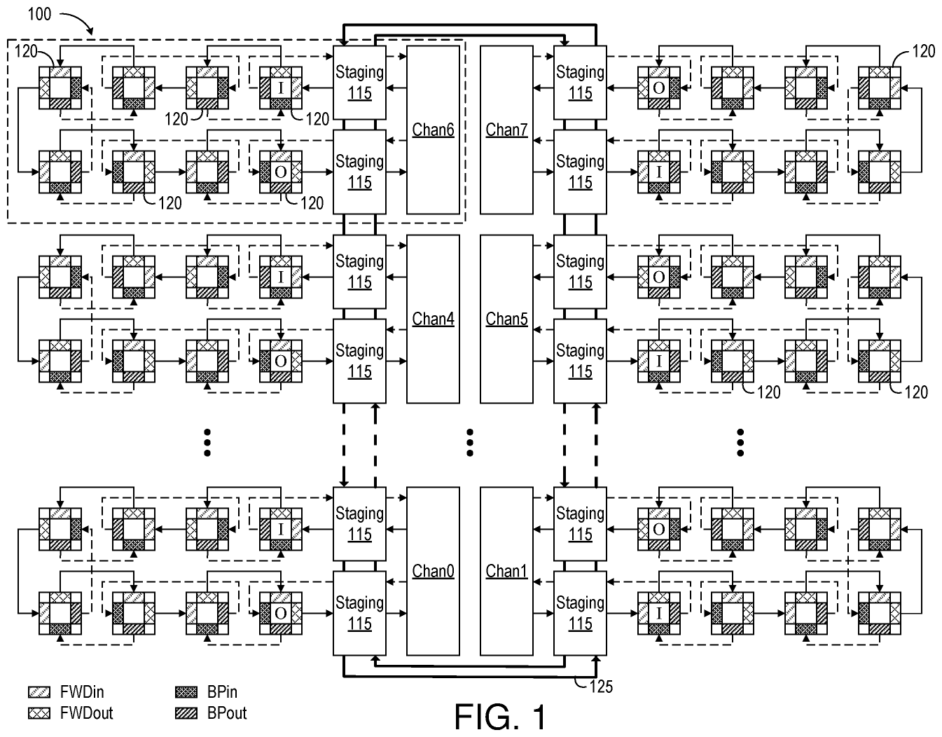

FIG. 1 illustrates an application-specific integrated circuit (ASIC) 100 for an artificial neural network with an architecture that minimizes connection distances between processing elements and memory (e.g. stacked memory dies), and thus improves efficiency and performance. ASIC 100 additionally supports minibatching and pipelined, concurrent forward and back propagation for training. Minibatching splits training data into small “batches” (minibatches), while pipelined and concurrent forward and back propagation support fast and efficient training.

ASIC 100 communicates externally using eight channel interfaces Chan[7:0]. A pair of staging buffers 115 next to each channel interface buffers data going to and from the memory core (not shown). Buffers 115 allow rate matching so that read and write data bursts from and to the memory can be matched to regular, pipeline movement of an array of processing tiles 120. In this context, a “tile” is a collection of processing elements arranged in a rectangular array (e.g. a square). Tiles can be placed and interconnected to allow efficient communication between tiles. Processing elements within a tile can operate as a systolic array, as detailed below, in which case tiles can be “chained” together to form larger systolic arrays. Though not shown, memory controllers (or state machines/sequencers) can be integrated in e.g. buffers 115 or tiles 120 to keep the processing pipeline running. Buffers 115 can be interconnected via one or more ring busses 125 for increased flexibility, for example to allow data from any channel to be sent to any tile, and to support use cases in which network parameters (e.g. weights and biases) are partitioned so that processing happens on portions of the neural network.

ASIC 100 is divided into eight channels, each of which can be used for minibatching. One channel comprises one channel interface Chan #, a pair of staging buffers 115, a series of processing tiles 120, and supporting memory (not shown). The channels are functionally similar. The following discussion is limited to the upper-left channel Chan6, which is bounded by a dashed border.

Processing tiles 120 can be described as “upstream” or “downstream” with respect to one another and with reference to signal flow in the direction of inference. Beginning with channel Chan6, the processing tile 120 labeled “I” (for “input”) receives input from one of buffers 115. This input tile 120 is upstream from the next tile 120 to the left. For inference, or “forward propagation,” information moves along the unbroken arrows through the chain of tiles 120, emerging from the ultimate downstream tile labeled “0” (for “output”) to another of staging buffers 115. For training, or “back propagation,” information moves along the broken arrows from the ultimate downstream tile labeled “0,” emerging from the ultimate upstream tile labeled “I.”

Each tile 120 includes four ports, two each for forward propagation and back propagation. A key at the lower left of FIG. 1 shows shading that identifies in each tile 120 a forward-propagation input port (FWDin), forward-propagation output port (FWDout), back-propagation input port (BPin), and back-propagation output port (BPout). Tiles 120 are oriented to minimize connection distances in an embodiment in which tiles 120 can occupy different layers of a 3D-IC. As detailed below, each tile 100 includes an array of processing elements, each of which can concurrently process and update partial results from both upstream and downstream processing elements and tiles in support of concurrent forward and back propagation.

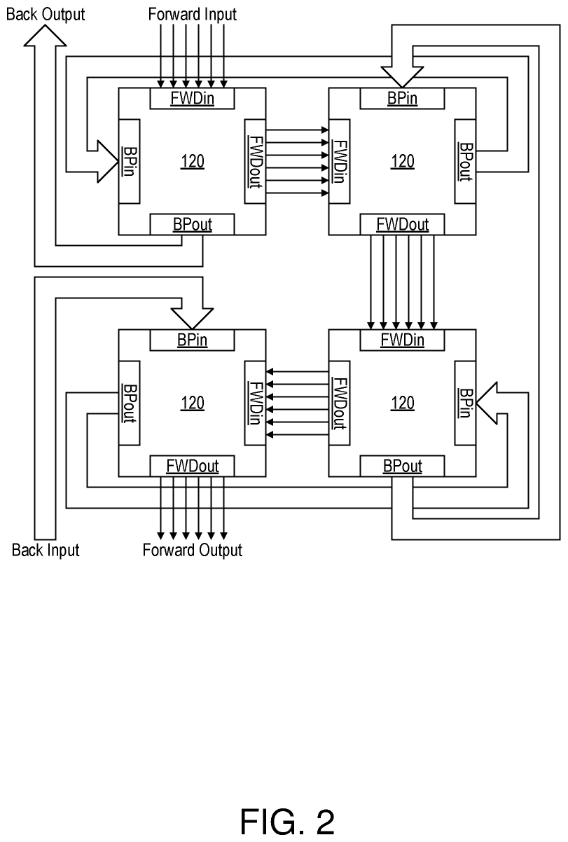

FIG. 2 illustrates four processing tiles 120 interconnected to support concurrent forward and back propagation. Thin, parallel sets of arrows represent the path of forward propagation through these four tiles 120. Solid arrows represent the path of back propagation. Forward- and back-propagation ports FWDin, FWDout, BPin, and BPout are unidirectional in this example, and both forward- and back-propagation sets of ports can be used concurrently. Forward propagation traverses tiles 120 in a clockwise direction beginning with the upper left tile. Back propagation proceeds counterclockwise from the lower left.

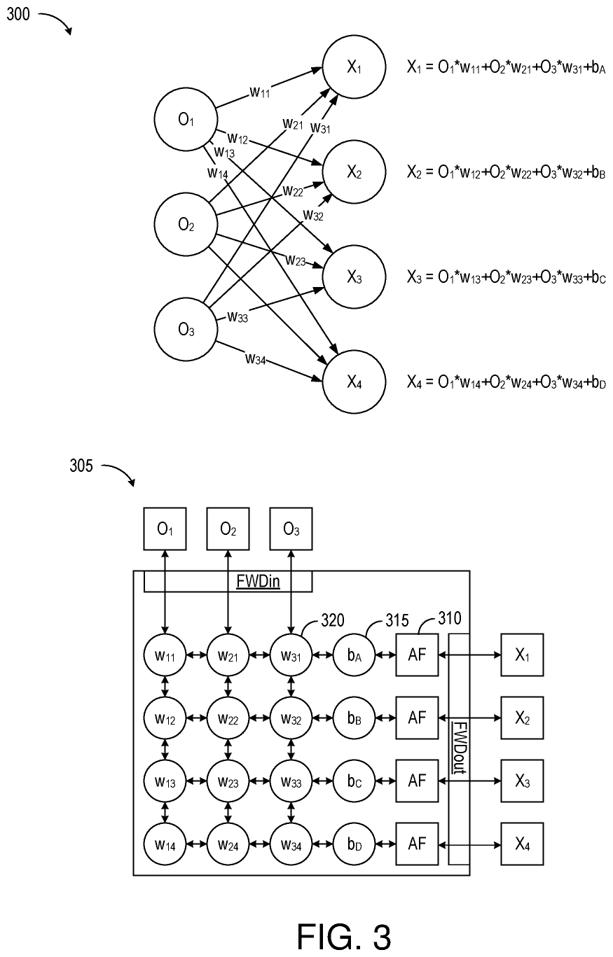

FIG. 3 includes a functional representation 300 and an array 305 of a neural network instantiated on a single processing tile 120. Representation 300 and array 305 illustrate forward propagation and omit back-propagation ports BPin and BPout for ease of illustration. Back propagation is detailed separately below.

Functional representation 300 is typical of neural networks. Data comes in from the left represented by a layer of neurons O₁, O₂, and O₃, each of which receives a respective partial result from one or more upstream neurons. Data leaves from the right represented by another layer of neurons X₁, X₂, and X₃ that convey their own partial results. The neurons are connected by weighted connections wᵢⱼ, sometimes called synapses, the weightings of which are determined in training. The subscript of each weighting references the origin and destination of the connection. The neural network calculates a sum of products for each output neuron following the equations shown in FIG. 3. A bias term b_{#} references a bias neuron that is omitted here for ease of illustration. Bias neurons and their use are well known so a detailed discussion is omitted.

Array 305 of a processing tile 120 is a systolic array of processing elements 310, 315, and 320. In a systolic array, data is transmitted in a stepwise fashion from one processing element to the next. For each step, each processing element computes a partial result as a function of the data received from an upstream element, stores the partial result in anticipation of the next step, and passes the result to a downstream element.

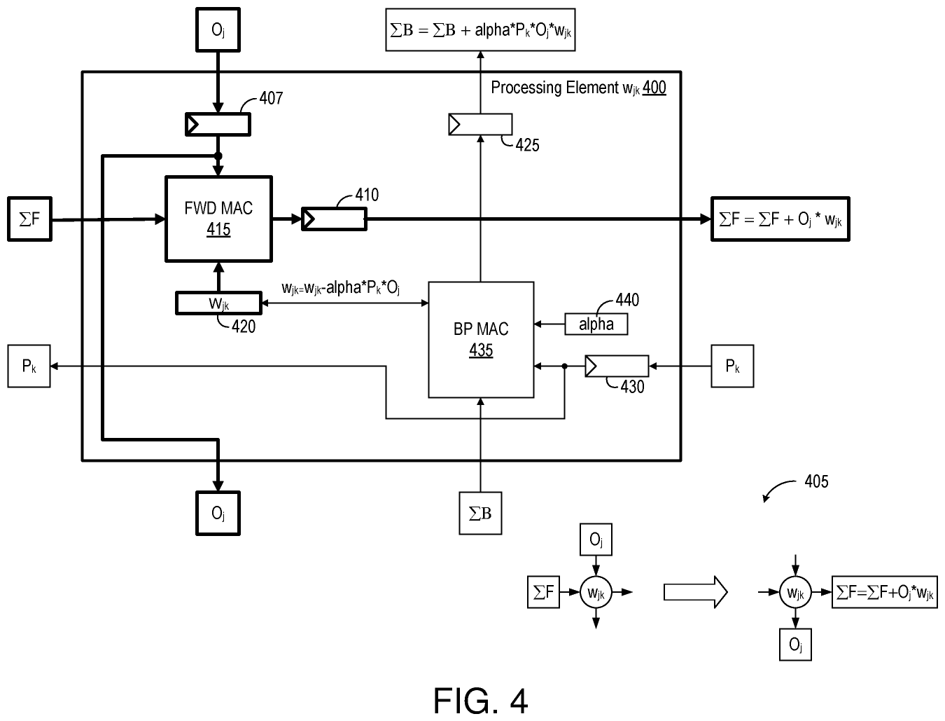

Elements 315 and 320 perform the calculations associated with forward propagation per functional representation 300. In addition, each of elements 310 performs an activation function that transforms the output of that node in ways that are well understood and unnecessary for the present disclosure. The layers, represented as neurons in representation 300, are depicted in array 305 as data inputs and outputs, with all computation performed by processing elements 310, 315, and 320. Processing elements 315 include simple accumulators that add a bias to a value that is accumulating, whereas elements 320 include multiply-accumulators (MACs or MAC units), each of which computes the product of two numbers and adds that product to an accumulating value. Each processing element 320 can include more than one MAC in other embodiments. Processing elements 310, 315, and 320 support pipelined and concurrent forward and back propagation, as detailed below, to minimize idle time and thus increase hardware efficiency. FIG. 4 depicts a processing element 400, an example of circuitry suitable for use as each processing element 320 of FIG. 3. Element 400 supports concurrent forward and back propagation. Circuit elements provided in support of forward propagation are highlighted using bold line widths. A diagram 405 at the lower right provides a functional description of element 400 transitioning between states of forward propagation. To start, element 400 receives as inputs a partial sum Oⱼ from an upstream tile and a forward-propagation partial result ΣF, if any, from an upstream processing element. After one compute cycle, processing element 400 produces an updated partial result ΣF=ΣF+Oⱼ*wⱼₖ and passes partial sum Oⱼ to another processing element 400. With reference to array 305 of FIG. 3, for example, the processing element 320 labeled W₂₂ passes a partial sum to the downstream element labeled W₃₂ and relays output O₂ to the element labelled w₂₃.

Returning to FIG. 4, processing element 400 includes, as support for forward propagation, a pair of synchronous storage elements 407 and 410, a forward-propagation processor 415, and local or remote storage 420 to store a weighting value, or weight wⱼₖ, for calculating partial sums. Processor 415, a so-called “multiply-accumulate” (MAC), calculates the forward partial sum and stores the result in storage element 410. In support of back propagation, processing element 400 includes another pair of synchronous storage elements 425 and 430, a back-propagation MAC processor 435, and local or remote storage 440 to store a value alpha that is used during training to update weight wⱼₖ. The functionality of the elements specific to back propagation are detailed below.

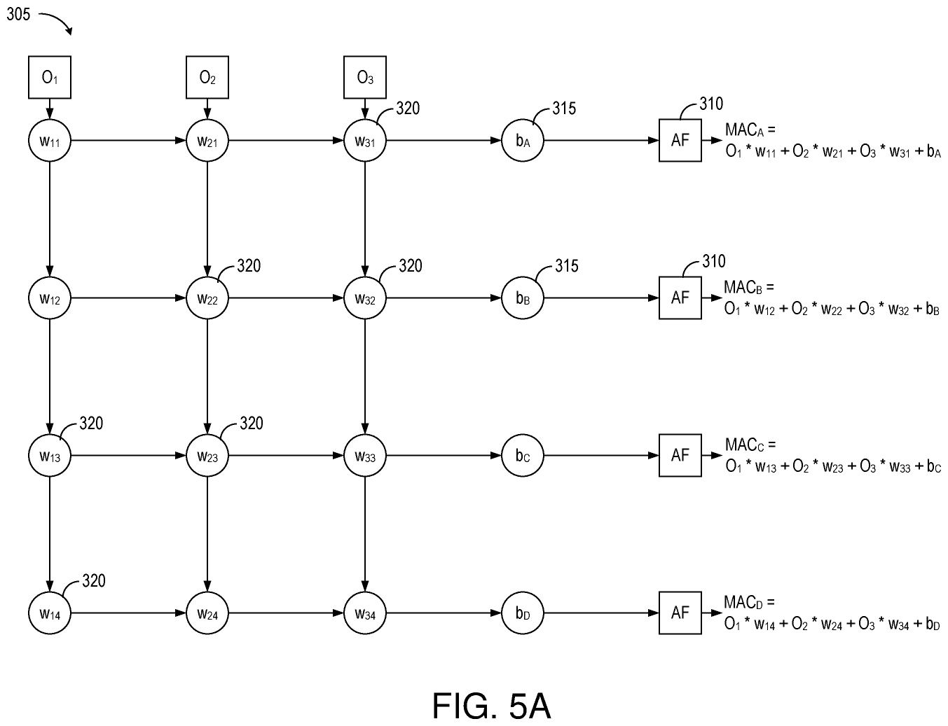

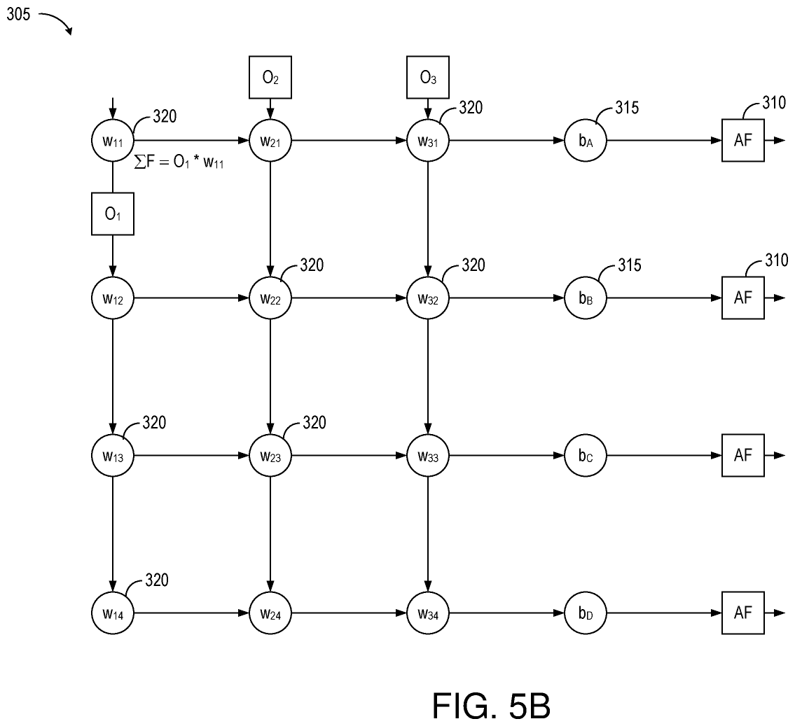

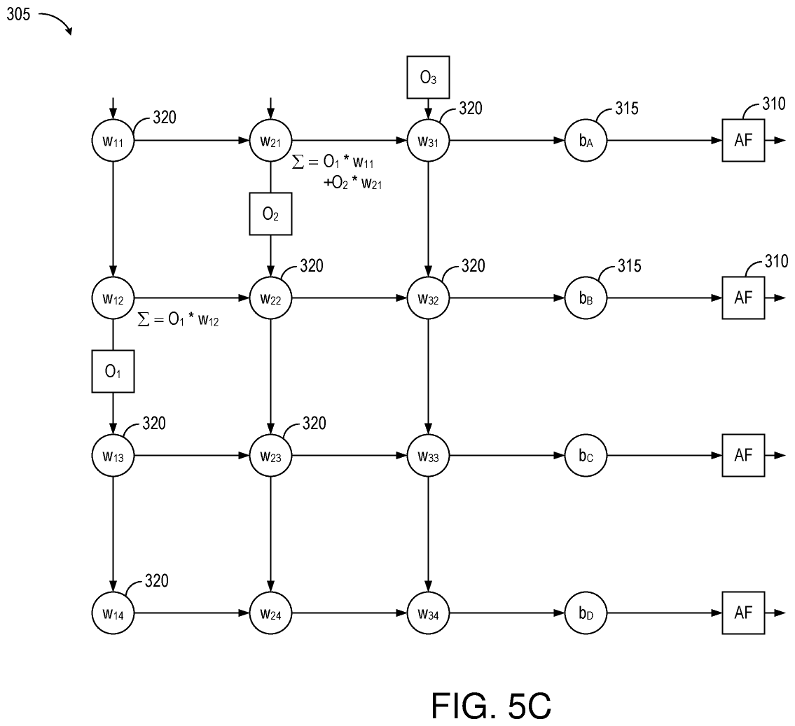

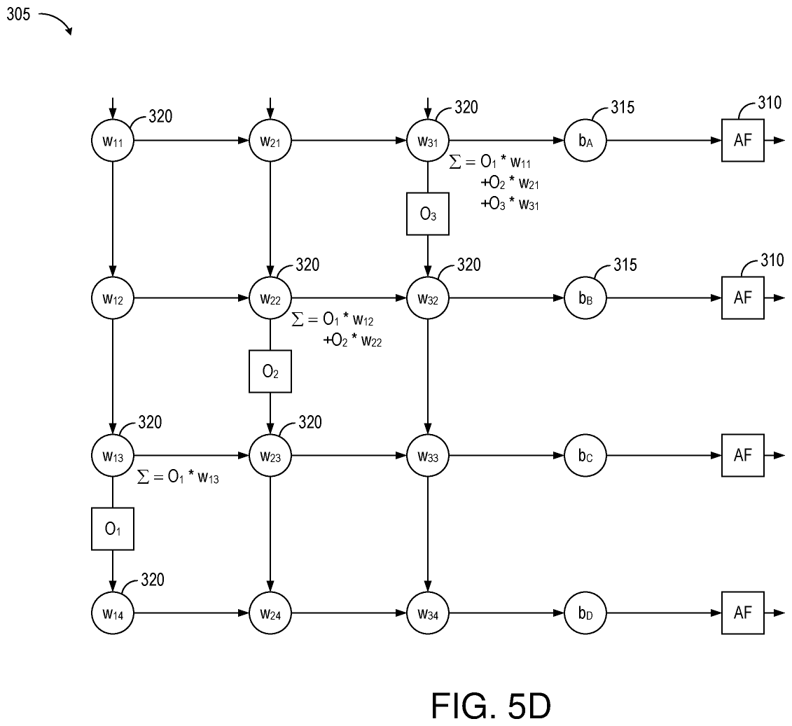

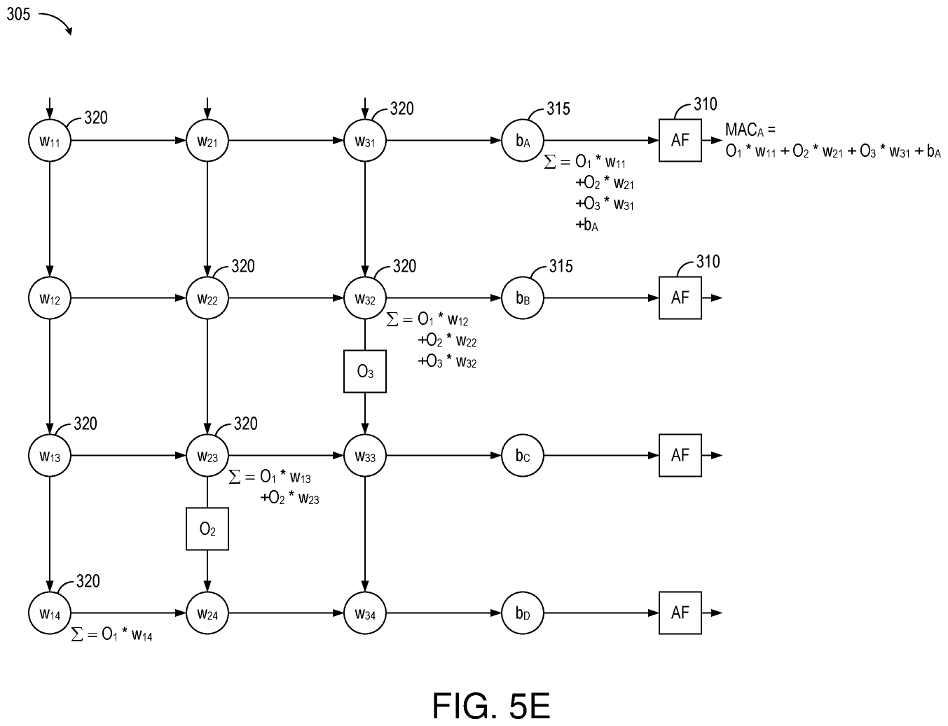

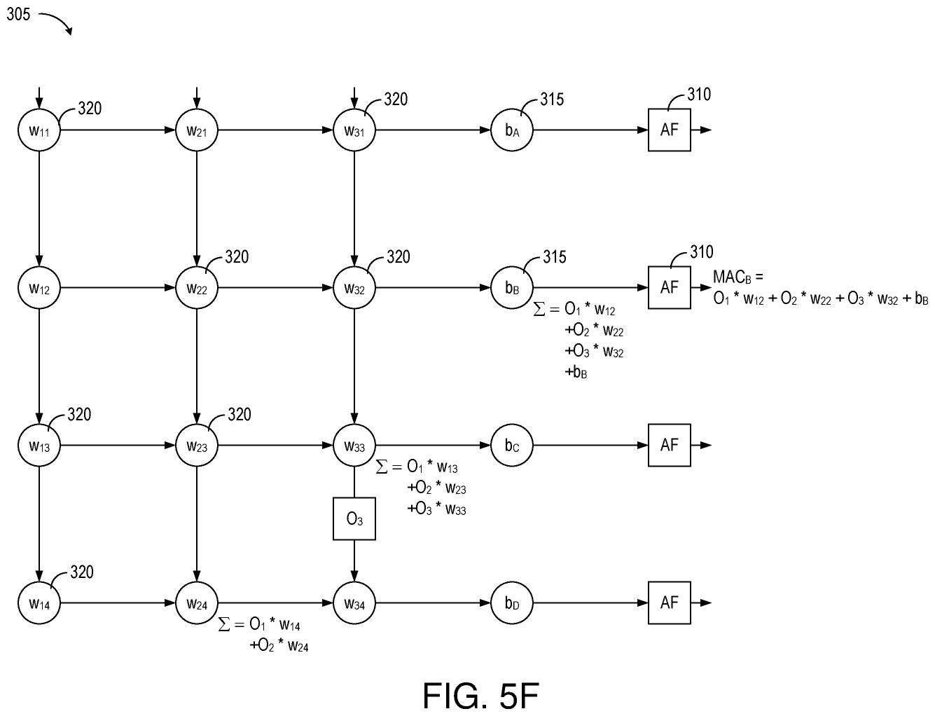

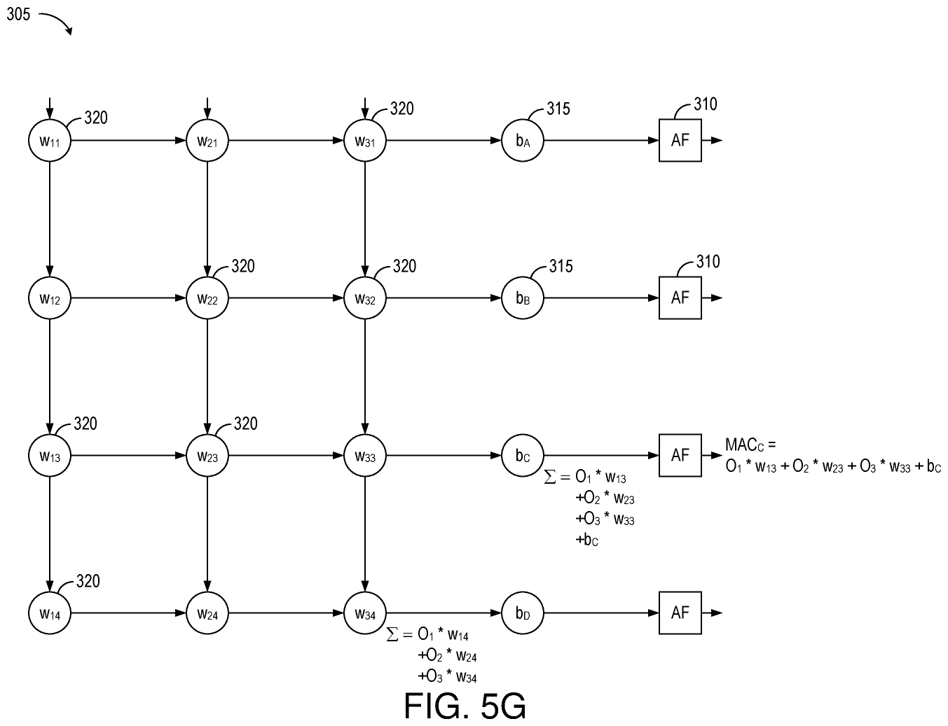

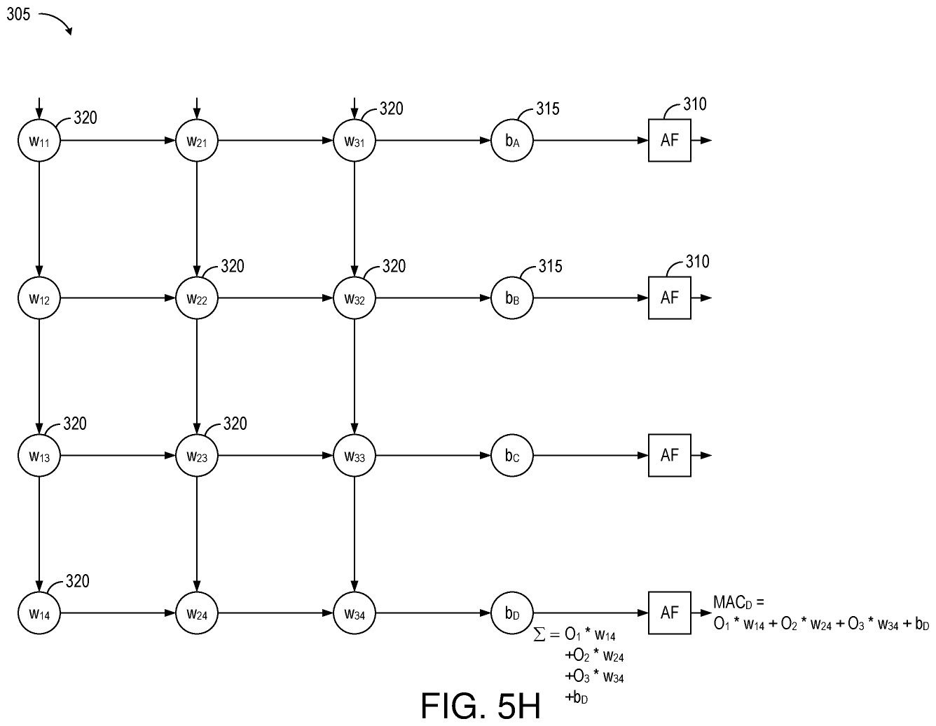

FIG. 5A through 5H each depict array 305 of FIG. 3 during a respective systolic processing cycle as outputs O₁, O₂, and O₃ are applied to successive processing elements 320. The processing elements are the same or similar but apply respective weights arrived at by training. The multiply-accumulate results MAC_{A-D} for each of four outputs from layer 305 are expressed mathematically.

FIG. 5B depicts array 305 after one processing cycle. The processing element 320 with weight w₁₁ clocks value O₁ through and passes partial sum ΣF=O₁*w₁₁ to the downstream processing element of weight w₂₁. Though not shown, the next value of O₁ is presented on the input to the processing element 320 with weight w₁₁ in anticipation of the next accumulation, keeping the “pipeline” full.

Next, in FIG. 5C, the processing element 320 with weight w₁₂ clocks value O₁ through and passes partial sum ΣF=O₁*w₁₂ to the downstream processing element of weight w₂₂. At the same time, the processing element 320 with weight w₂₁ clocks value O₂ through and passes partial sum ΣF=O₁*w₁₁*O₂*w₂₁ to the downstream processing element of weight w₃₁. The process continues in the next cycle, FIG. 5D, so that value O₃ begins to propagate down through array 305 and contribute to the accumulating forward partial results.

Turning to FIG. 5E, the accumulator 315 labeled b_{A} adds an offset to the accumulated result from top row of processing elements 320 and the resulting sum of products is treated to whatever activation function is applied by activation-function processing element 310. The first forward partial result from array 305 is thus produced. The output MAC_{A} is shown without application of an activation function because the equation illustrates the flow of MACs through array 305.

FIGS. 5F-H complete the calculation of all four partial sums MAC_{A-D} as the outputs from the preceding layer of the neural network move down through array 305 and partial sums move to the right. The partial sums are presented in succession. Though not shown, each row of processing elements presents a successive partial sum at each processing cycle.

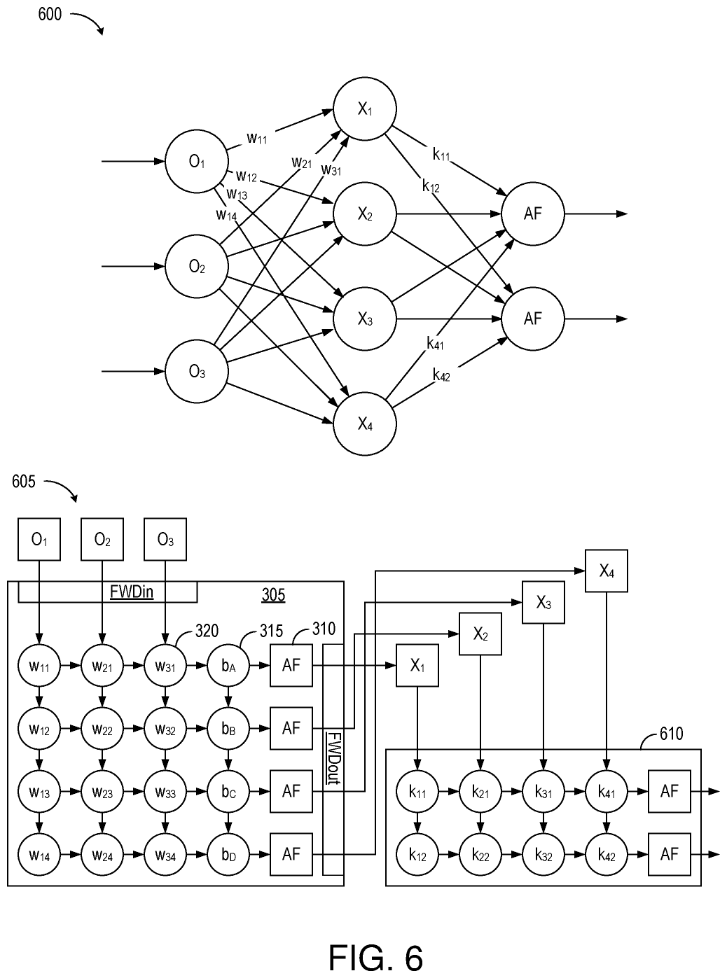

FIG. 6 includes a functional representation 600 and a systolic array 605 of a neural network instantiated across two dissimilar processing tiles, one tile 120 of the type detailed previously communicatively coupled to a downstream tile that includes an array 610 with eight processing elements identified by their respective weights kᵢⱼ and a pair of processing elements that impose activation functions. The processing elements of second array 610 can be physically identical to those of tile 120. Array 605 accumulates partial results in the manner detailed above in connection with array 305. The additional layer further accumulates partial results, sequentially, starting with partial results X₁-X₄ as inputs. Any number of network layers can be similarly combined to support ever more complex computation.

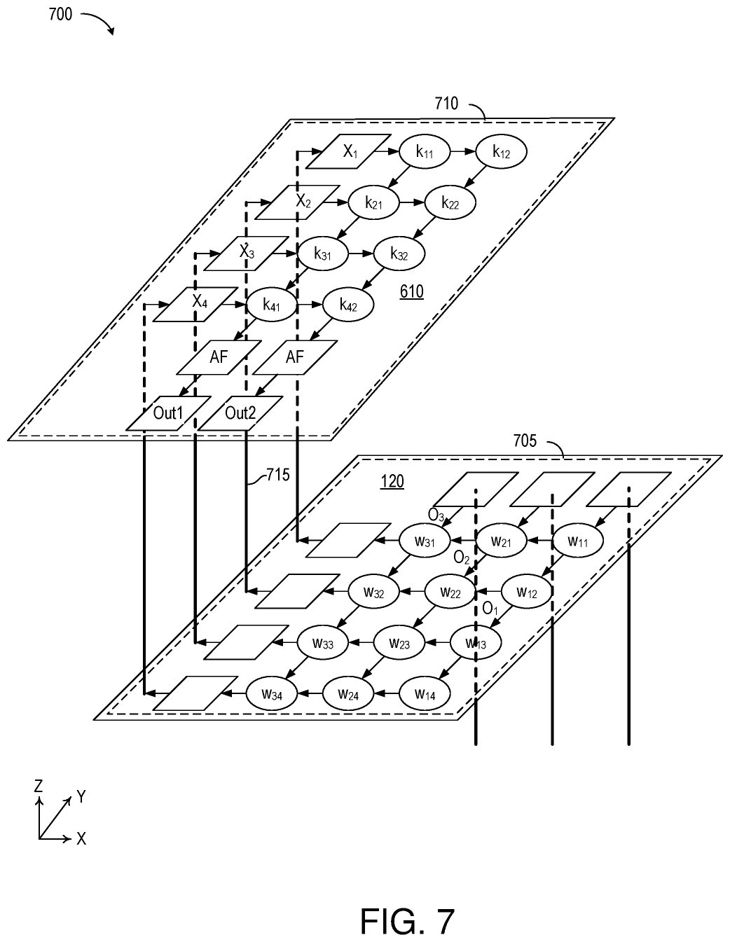

FIG. 7 depicts a 3D-IC 700 that instantiates the array of a tile 120 and array 610 of the neural network depicted in FIG. 6. Tile 120 is integrated in a lower IC die 705 that is physically and electrically connected to an upper die 710 on which array 610 is integrated. The tiles of systolic arrays are laid out and disposed relative to one another to minimize the lengths of electrical connections 715, conductive through-silicon vias in one embodiment. The processing elements and related circuits and connections can be laid out to minimize connection lengths, and thus power consumption and inter-element delay.

In forward propagation, outputs O₁, O₂, and O₃ from a prior layer (not shown) propagate (−y direction) through tile 120 as detailed previously. Partial sums accumulate right to left (−x) and are conveyed upward (z) to array 610 on connections 715 as outputs X₁, X₂, X₃, and X₄. These outputs then propagate left to right across array 610 (x) as partial sums accumulate (−y) toward outputs Out1 and Out2.

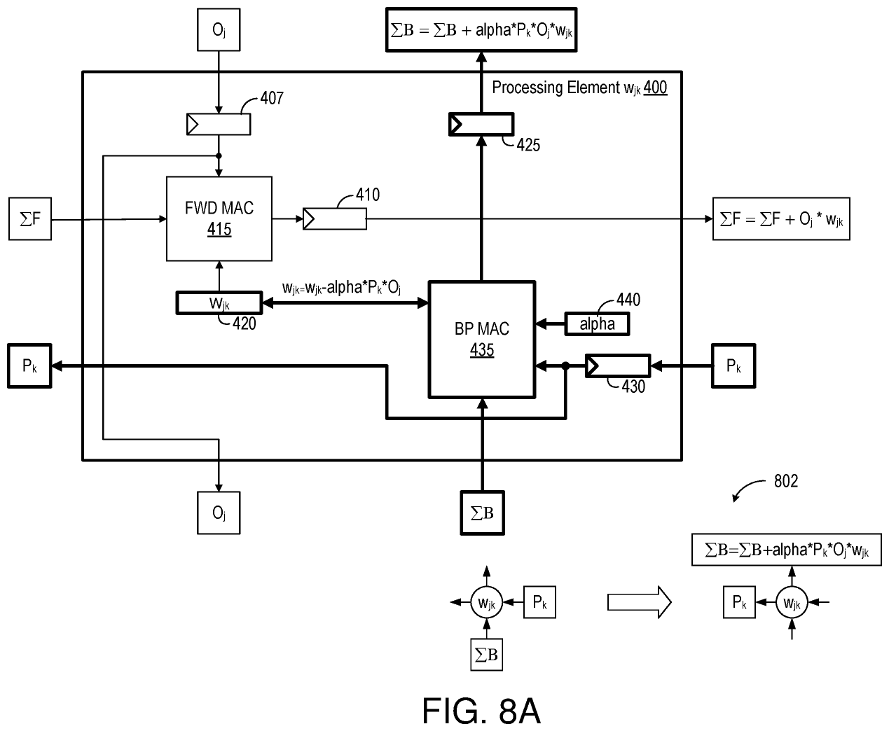

FIG. 8A depicts processing element 400 of FIG. 4 with circuit elements provided in support of back propagation highlighted using bold line widths. A diagram 802 at the lower right provides a functional description of element 400 transitioning between states of back propagation. Element 400 receives as inputs a partial sum Pₖ from a downstream tile and a back-propagation partial result ΣB, if any, from a downstream processing element. After one compute cycle, processing element 400 produces an updated partial result ΣB=ΣB+alpha*Pₖ*Oⱼ*wⱼₖ to an upstream processing element 400. Alpha specifies a learning rate by controlling how much to change the weight in response to estimated errors.

FIG. 8B depicts a processing element 800 similar to processing element 400 of FIGS. 4 and 8A, with like-identified elements being the same or similar. A MAC 805 in service of back propagation includes four multipliers and two adders. MAC 805 stores two learning-rate values Alpha1 and Alpha2, which can adjust back-propagation calculations differently. For each calculation, one might want to add a scale factor to emphasize or de-emphasize how much the calculation affects an old value. Processing elements can have more or fewer multipliers and adders in other embodiments. For example, processing element 800 can be simplified by reusing hardware (e.g., multipliers or adders), though such modification may reduce processing speed.

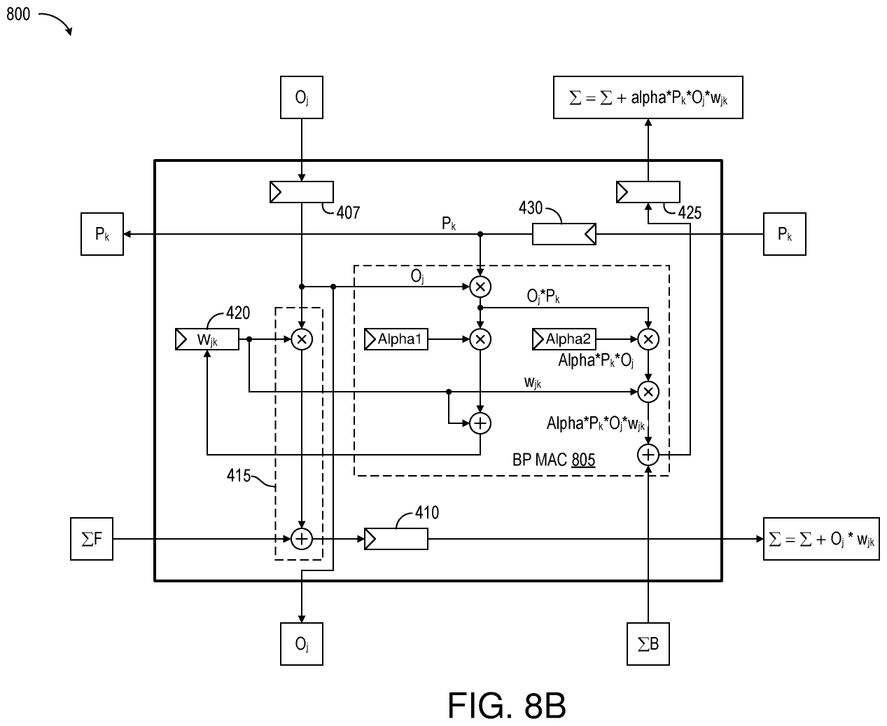

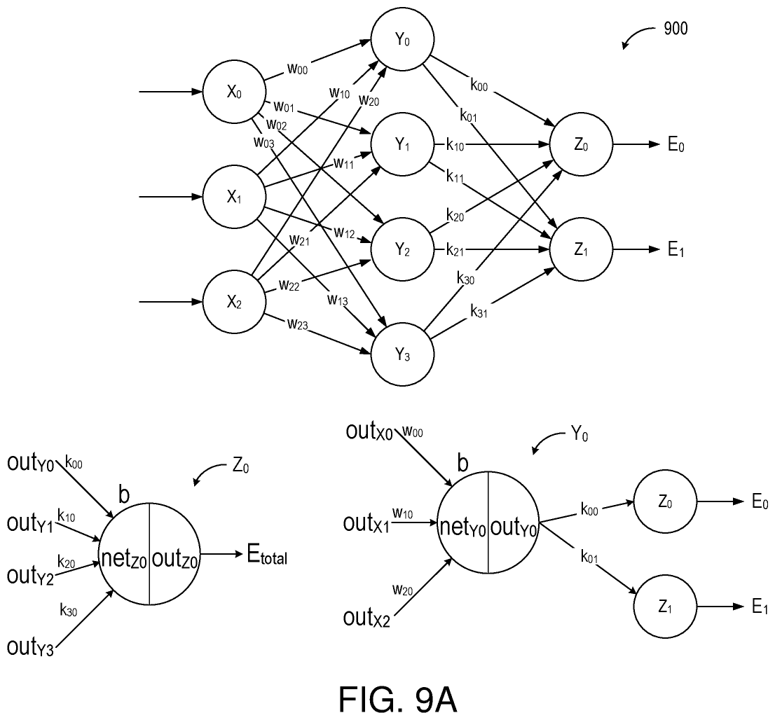

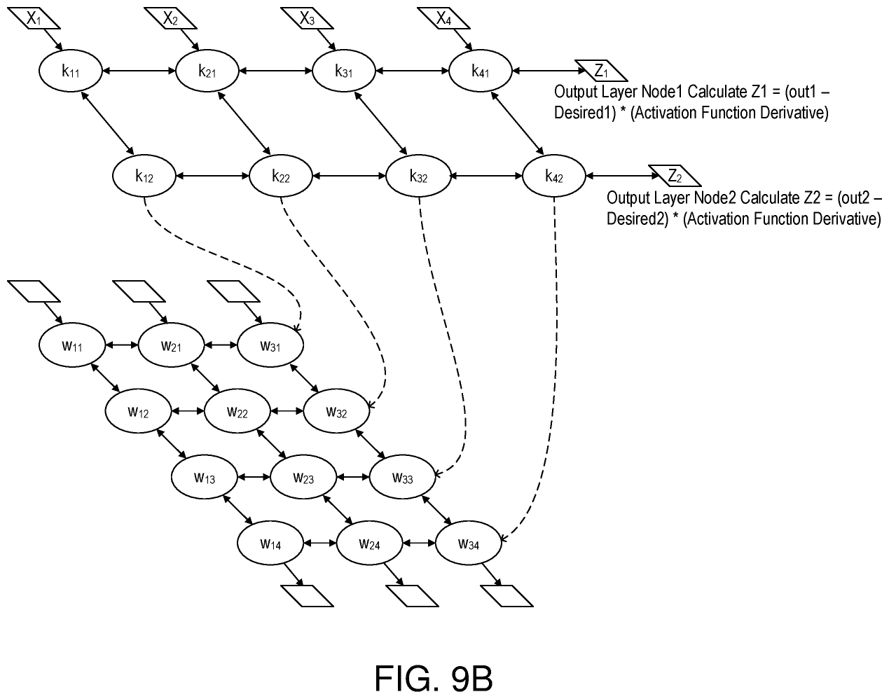

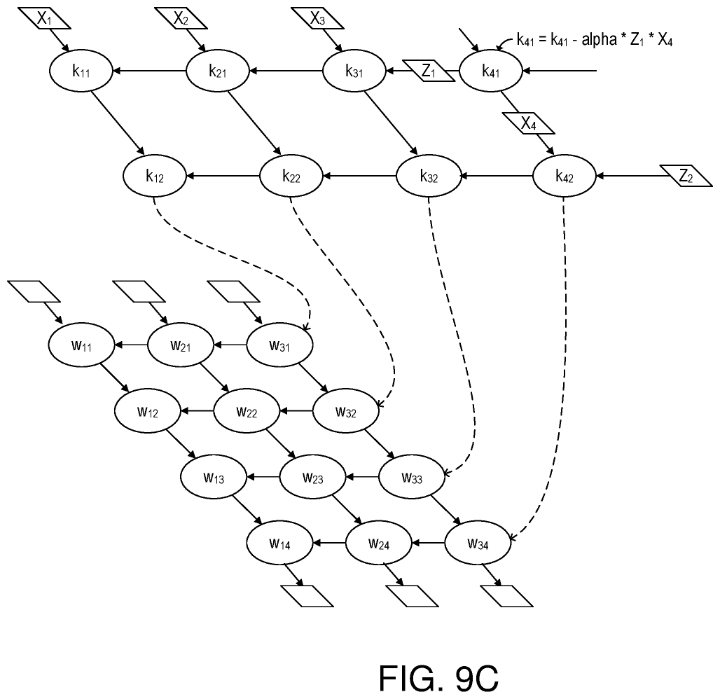

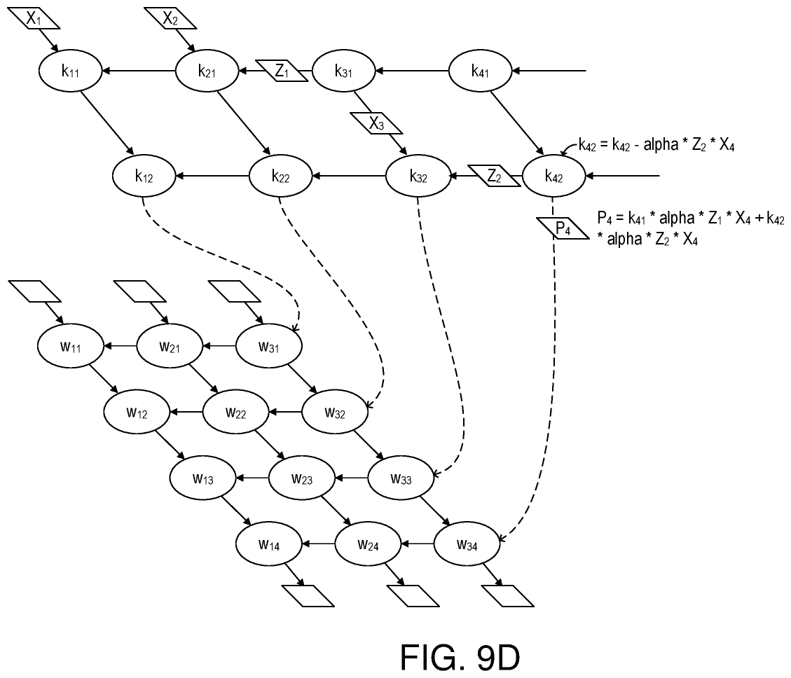

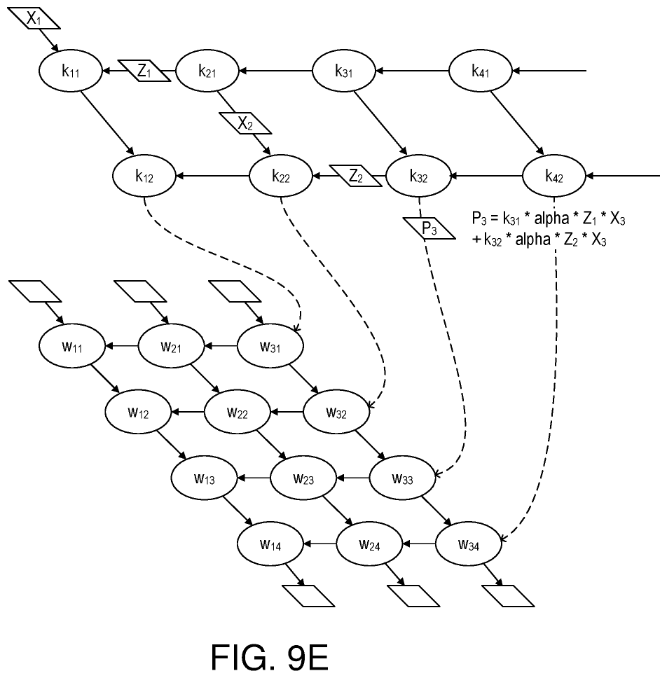

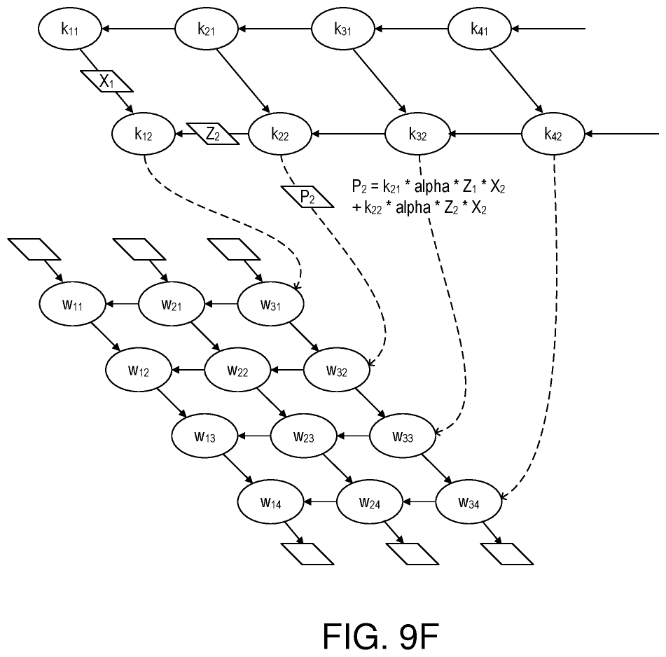

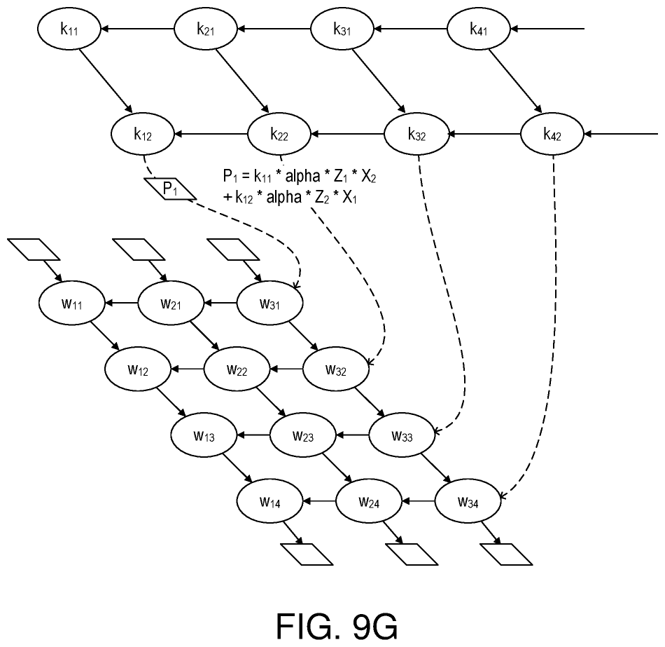

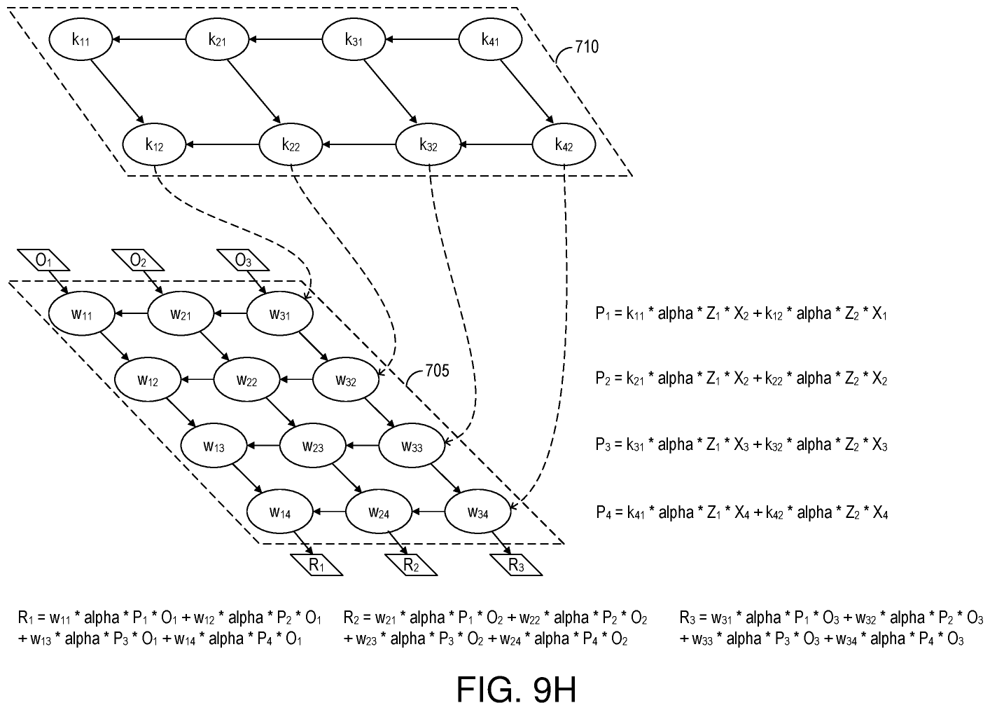

FIGS. 9A-9H illustrate information flow during back propagation through processing tile 120 and array 610 interconnected in the manner illustrated in FIG. 7. For back propagation, the calculations performed at the last layer of the neural network are different than for all other layers. Equations can vary by implementation. The following examples illustrate the hardware used for layers other than the output layer because they require more computation.

FIG. 9A illustrates a simple neural network 900 that includes an input layer X[2:0], a hidden layer Y[3:0], and an output layer Z[1:0] producing errors E[1:0]. Neuron Z₀ of the output layer—neurons are also called “nodes”—is shown divided into netₒ₀ and outₒ₀ at lower left. Neuron Y₀ of the hidden layer is shown divided into net_{Y0} and out_{d0} at lower right. Each neuron is provided with a respective bias b. This graphical representation, for ease of illustration, represents a systolic array of processing elements that support concurrent forward and back propagation as detailed herein.

Output-layer calculations for back propagation use the total error from the previous step. Stated mathematically for N outputs outₒ:

Eₜₒₜₐₗ=½(Desiredₒ₀−outₒ₀)²+ . . . ½(Desired_{oN-1}−out_{oN-1})² Eq. 1
In network 900 N=2. The gradient for each weight is calculated for each weight based on its contribution to total error Eₜₒₜₐₗ. For each output node O {
   For each incoming weight/bias connected to output node O {
   Use the chain rule to determine the error contribution of the weight/bias and adjust it.
This illustration assumes e.g. a Sigmoid activation function, the derivative of which is equation 4 below. Considering total error Eₜₒₜₐₗ from output node Z₀:

$$\begin{matrix}\begin{matrix}\frac{\partial {E}_{total}}{\partial {k}_{00}} = \frac{\partial {E}_{total}}{\partial {out}_{Z 0}} ⋆ \frac{\partial {out}_{Z 0}}{\partial {net}_{Z 0}} * \frac{\partial {net}_{Z 0}}{\partial {k}_{00}} & Eq . 2\end{matrix} \\ \begin{matrix}\frac{\partial {E}_{total}}{\partial {out}_{Z 0}} = {out}_{Z 0} - {Desired}_{Z 0} & Eq . 3\end{matrix} \\ \begin{matrix}\frac{\partial {out}_{Z 0}}{\partial {net}_{Z 0}} = {out}_{Z 0} * ( 1 - {out}_{Z 0} ) & Eq . 4\end{matrix} \\ \begin{matrix}\frac{\partial {net}_{Z 0}}{\partial {k}_{00}} = {out}_{Y 0} & Eq . 5\end{matrix} \\ \begin{matrix}{k}_{00} = {k}_{00} - α * \frac{\partial {E}_{total}}{\partial {k}_{00}} & Eq . 6\end{matrix} \\ \} \\ \}\end{matrix}$$

Hidden-layer calculations for back propagation are also based on the total error but the equations are different. One embodiment, for example, works as follows: For each hidden node Y {

Use the chain rule to determine the error contribution of the weight and adjust it:

$$\frac{\partial {E}_{total}}{\partial {w}_{00}} = {\sum }_{0} ( \frac{\partial {E}_{total}}{\partial {out}_{Z 0}} * \frac{\partial {out}_{Z 0}}{\partial {net}_{Z 0}} * \frac{\partial {net}_{Z 0}}{\partial {Y}_{0}} ) * \frac{\partial {out}_{Y 0}}{\partial {net}_{Y 0}} * \frac{\partial {net}_{Y 0}}{\partial {w}_{00}} \qquad Eq . 7$$

$$\frac{\partial {E}_{total}}{\partial {w}_{00}} = \frac{\partial {E}_{total}}{\partial {out}_{Y 0}} * \frac{\partial {out}_{Y 0}}{\partial {net}_{Y 0}} * \frac{\partial {net}_{Y 0}}{\partial {w}_{00}} \qquad Eq . 8$$

$$\frac{\partial {E}_{total}}{\partial {out}_{Y 0}} = \frac{\partial {E}_{0}}{\partial {out}_{Y 0}} + \frac{\partial {E}_{1}}{\partial {out}_{Y 0}} \qquad Eq . 9$$

$$\frac{\partial {out}_{Y 0}}{\partial {net}_{Y 0}} = {out}_{Y 0} * ( 1 - {out}_{Y 0} ) \qquad Eq . 10$$

$$\frac{\partial {net}_{Y 0}}{\partial {w}_{00}} = {out}_{X 0} \qquad Eq . 11$$

$${w}_{00} = {w}_{00} - α * \frac{\partial {E}_{total}}{\partial {w}_{00}} \qquad Eq . 12$$

$$\} \\ \}$$

If a neural network has multiple hidden layers, error term Eₜₒₜₐₗ is the error at the next layer of nodes, which can be calculated by the difference between the actual and desired outputs of the nodes. The desired output is calculated in the previous iteration when the next layer was adjusted.

Back propagation works from the outputs to the inputs, so the previous layer's adjustments are known when the current layer's adjustments are being calculated. The process can be conceptualized as a sliding window over three layers of nodes, where one looks at the errors of the rightmost layer and uses them to compute adjustments to weights coming into the middle layer of the window.

With reference to FIG. 9B, back propagation begins with the computation of inputs Z₁ and Z₂ for respective nodes Node1 and Node2, each of which is a product of the difference between the activation-function derivative and the difference between the actual output and the desired output.

Turning to FIG. 9C, the processing element of weight k₄₁ (1) relays value X₄ to the processing element of weight k₄₂, (2) relays value Z₁ to the processing element of weight k₃₁, and (3) calculates and stores an updated weight k₄₁=k₄₁−alpha*Z₁*X₄. Next, illustrated in FIG. 9D, the processing element of weight k₃₁ behaves likewise to update weight k₃₁ (k₃₁=k₃₁−alpha*Z₁*X₃). Concurrently, the processing element of weight k₄₂ passes value Z₂, updates weight k₄₂, and passes a partial sum P₄=k₄₁*alpha*Z₁*X₄+k₄₂*alpha*Z₂*X₄) to the processing element of weight w₃₄ in the lower stratum. The remaining processing elements of the upper stratum behave similarly to update each of their weights and generate partial results P₁-P₃ (FIGS. 9E-9G).

FIG. 9H illustrates how signals traverse the lower stratum (die 705) in back propagation. Partial results P₁-P₄ are shown together but in practice leave the upper stratum (die 710) to enter the lower stratum in reverse numerical order as illustrated in FIGS. 9B-9G. For brevity, partial results R₁-R₃ are depicted as completed mathematical expressions in lieu of stepping through each cycle as was done for the upper stratum.

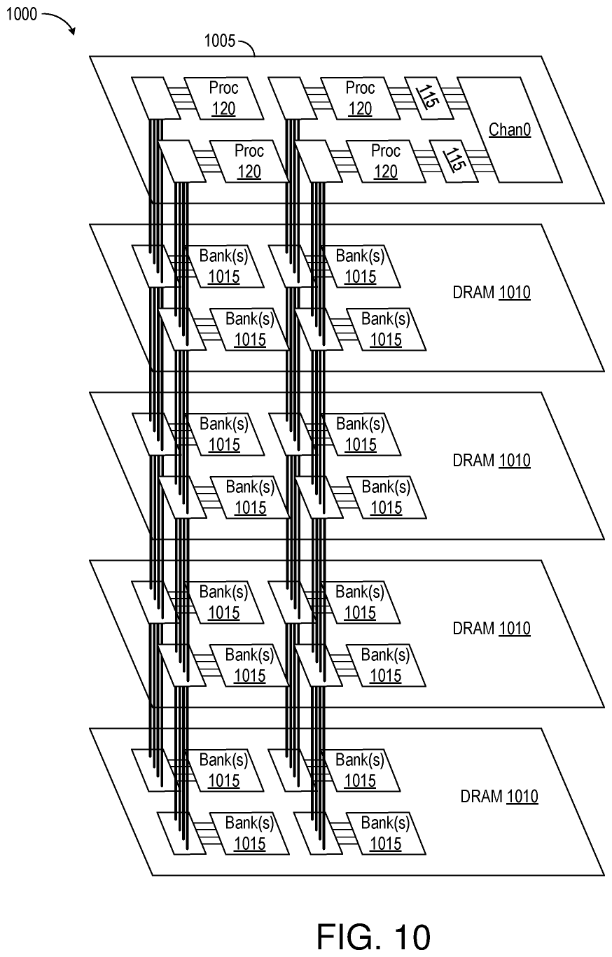

FIG. 10 depicts a die stack 1000 as an artificial neural network application in accordance with another embodiment. Semiconductor die (e.g., an ASIC) 1005 is an IC that incorporates processing elements or tiles of processing elements as a base layer or layers within a stack of integrated-circuit dies (e.g., DRAM dies). The layers are illustrated as separate but would be manufactured as stacked silicon wafers or dies interconnected using e.g. through-silicon vias (TSVs) or Cu—Cu connections so that the stack behaves as a single IC. The dies can be separate or in separate stacks in other embodiments.

The top layer is a semiconductor die 1005 with circuitry similar to that of ASIC 100 of FIG. 1, with like-identified elements being the same or similar. The processing elements and related components interoperate for forward and back propagation e.g. in the manner detailed above. The lower layers are memory dies 1010, DRAM in this example, with banks 1015 laid out to establish relatively short connections to processing elements 120. Banks 1015 form a high-bandwidth memory with vertical vaults for storing e.g. partial results. Processing elements 120 thus have access to high-bandwidth memory in support of e.g. learning and inference calculations. Banks 1015 can be complete banks or portions of banks (e.g. mats of bit cells).

### Convolutional Neural Networks

Convolutional neural networks (CNNs) are commonly used for e.g. image analysis. As with the foregoing examples, CNNs can be implemented using systolic arrays. In image processing, an image represented as a two-dimensional matrix of pixel values is convolved with one or more “kernels.” Each kernel, represented as a two-dimensional matrix of values smaller than the image matrix, is slid over the image matrix—generally starting at the top left corner—to all positions on the image matrix over which the kernel matrix fits. For example, a 3×3 kernel matrix may be slid over every 3×3 grouping of pixel values in a much larger image matrix. A dot product of the kernel matrix and underlying grouping of pixel values is recorded for each grouping to produce a filtered image matrix.

Processing elements in a convolutional systolic array differ from those detailed previously in connection with e.g. FIG. 3. Reflecting their use in applying kernels, convolution nodes are locally connected to a small region of the width and height of a layer before it (e.g., a 3×3 or 5×5 neighborhood of image pixels), called a receptive field. Hidden-layer weights can take the form of a convolutional filter applied to the receptive field.

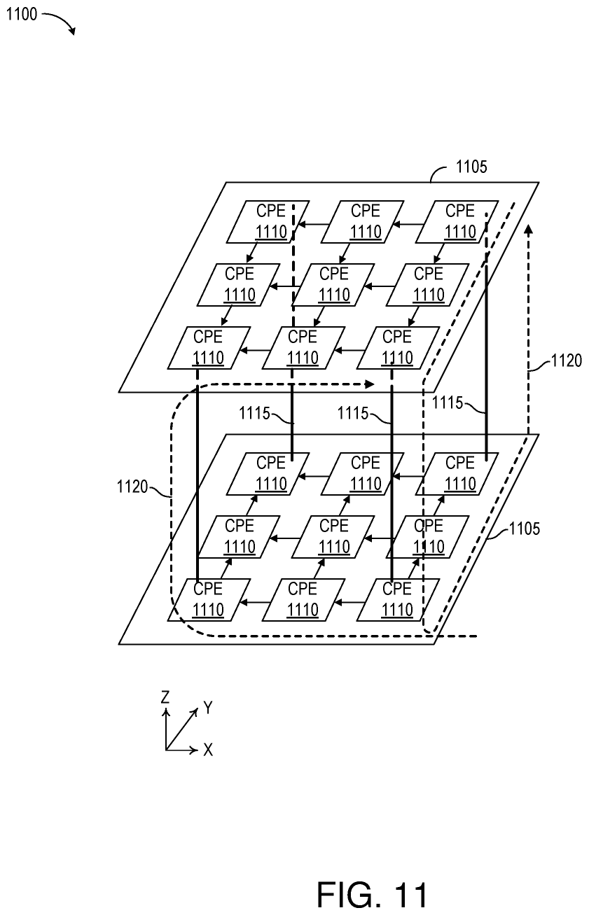

FIG. 11 depicts a 3D-IC 1100 that instantiates a CNN using a pair of physically and electrically interconnected IC dies 1105, each of which includes a systolic array of convolutional processing elements (CPEs) 1110. CPEs 1110 can be grouped in tiles that are laid out and disposed relative to one another to minimize the lengths of electrical connections 1115. Though not shown, each CPE 1110 has or has access to memory with e.g. DRAM memory cells.

The computational resources of CPEs 1110 are well known to those of skill in the art so a detailed discussion is omitted. Briefly, each CPEs 1110 include e.g. multipliers, adders, rectified linear units, pooling modules, and registers for storing inputs, weights, and partial sums. The multipliers and adders perform convolutions to obtain the partial sums. The rectified linear units apply a suitable activation function to the partial sums. A pooling module in each CPE realizes the maximum or average pooling operation, which is stored in a local buffer. CPEs 1110 can be adapted to alternatively support either convolution or other functions, such as those attributed to processing elements 320 of FIG. 3. In both upper and lower dies 1105, partial sums accumulate through CPEs 1110 in the same direction, from right to left (−x). Data flows in opposite directions, however, top to bottom (−y) in upper die 1105 and bottom to top (y) in lower die 1105. Connections 1115 at the edges of dies 1105 allow partial sums and data to flow in loops 1120 to nearest neighbor CPEs 1110 in different dies. These relatively short signal paths convey signals along the z dimension with minimal power and delay.

CNNs commonly apply more than one kernel to a given data set (e.g., an image matrix). 3D-IC 1100 applies multiple kernels to the same data set concurrently, which saves time. Support for data flowing in loops 1120 allows 3D-IC to rotate multiple kernels across image data in a manner that applies the kernels concurrently to different parts of the data set. This looping improves parallelism, which in turn improves efficiency and speed performance.

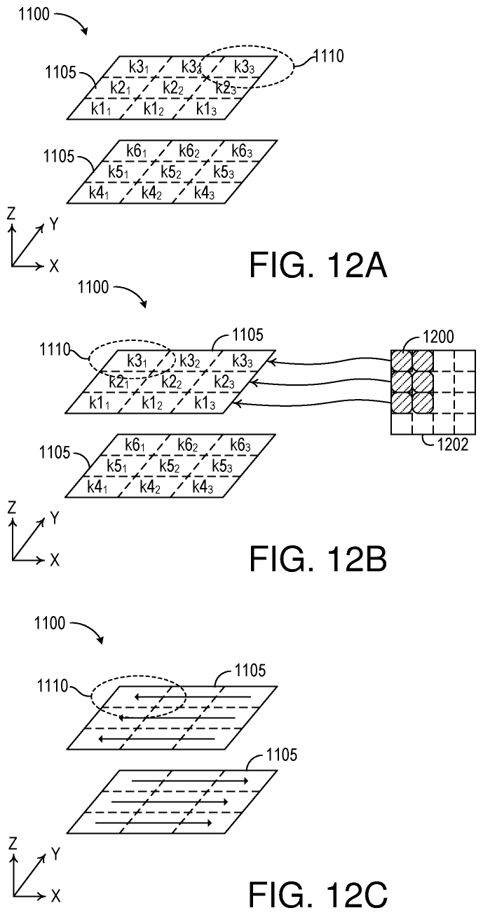

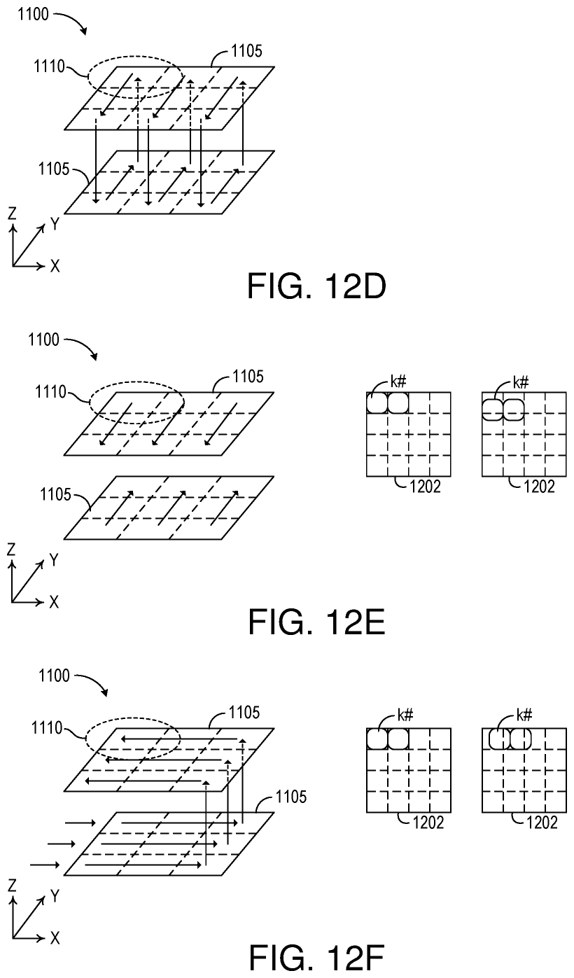

FIGS. 12A-12F include simplified views of 3D-IC 1100 of FIG. 11 showing each IC die 1105 as a systolic three-by-three array in which each element is a CPE 1110. These views illustrate how 3D-IC 1100 exploits the nested looping of data between IC dies 1105 for fast and efficient convolution.

Beginning with FIG. 12A, which illustrates a MAC loop, six kernels k1-k6 are loaded into the processing elements 1110 of upper and lower dies 1105. Each kernel k # is divided into three sub-kernels k #₁, k #₂, and k #₃ to match the capability of the hardware. Next, depicted in FIG. 12B, small blocks of activations 1200 (e.g. portions of an image matrix 1202) are split and mapped to processing elements 1110, again to match the capability of the hardware. Activations 1200 are then stepped though CPEs 1110 to interact with the sub-kernels (FIG. 12C) such that partial sums accumulate right to left (−x) in the upper layer and left to right (x) in the lower layer. This process generates a multiply/accumulate output for each kernel.

FIG. 12D shows the next movement, that of kernels k1 through k6 in a first kernel-stride loop such that each kernel comes across each row of CPE 1110 at least once. Kernels move both in plane within each die 1105 (±y) and between dies 1105 (±z), with alternate dies passing kernels in opposite directions. Then, in FIG. 12E, rows of activations 1200 in each die 1105 are moved to another row in the same die. This movement has the effect of striding kernels k # downward over image data 1202 as shown on the right.

In the final movement, illustrated in FIG. 12F, rows of activations 1200 move from one column of CPEs 1110 to the other, left-to-right (x) across the bottom IC die 1105, up to top IC die 1105 (z), and right-to left (−x) across the top IC die 1105. This movement of data has the effect of striding kernels k # to the right over image 1202, orthogonal to the effect of FIG. 12E, as illustrated on the right of FIG. 12F.

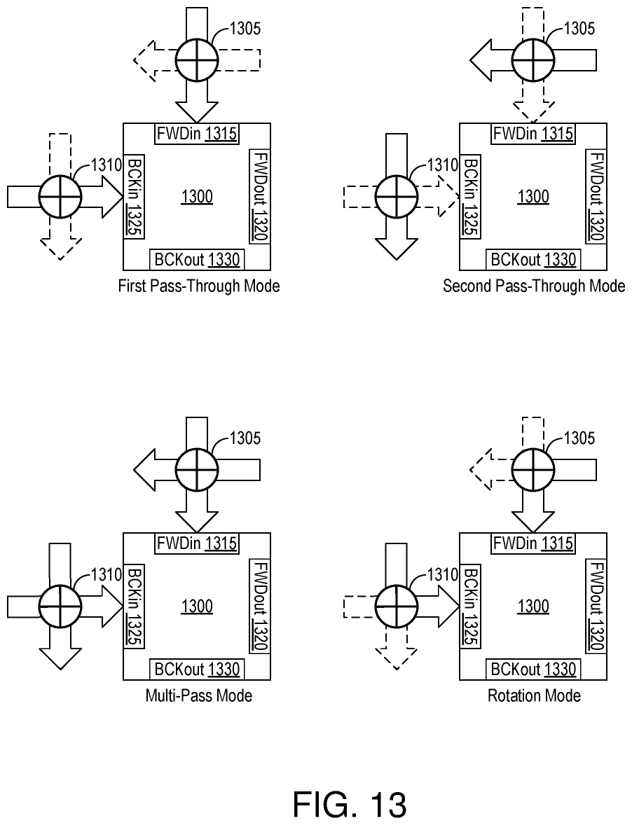

FIG. 13 depicts four instances of a tile 1300 with forward-propagation input switches 1305 and back-propagation input switches 1310 that together support the connectivity and related signal flow detailed above in connection with FIGS. 12A-12F. Tiles 1300, in this embodiment, additionally support the functions attributed above to one or more of tiles 310, 315, and 320.

Tile 1300 includes a forward-propagation input port 1315, a forward-propagation output port 1320, a back-propagation input port 1325, and a back-propagation output port 1330. Though not shown, tile 1300 additionally includes a systolic array of CPEs 1110 of the type detailed previously to perform convolutions. Each switch 1305 can be placed in one of four modes depending upon how signals are to be routed. These modes are depicted as a first pass-through mode (upper left) that conveys information to forward-propagation input port 1315; a second pass-through mode (upper right) that bypasses the corresponding forward-propagation input port 1315; a multi-pass mode (lower left) that combines the first two modes; and a rotation mode (lower right).

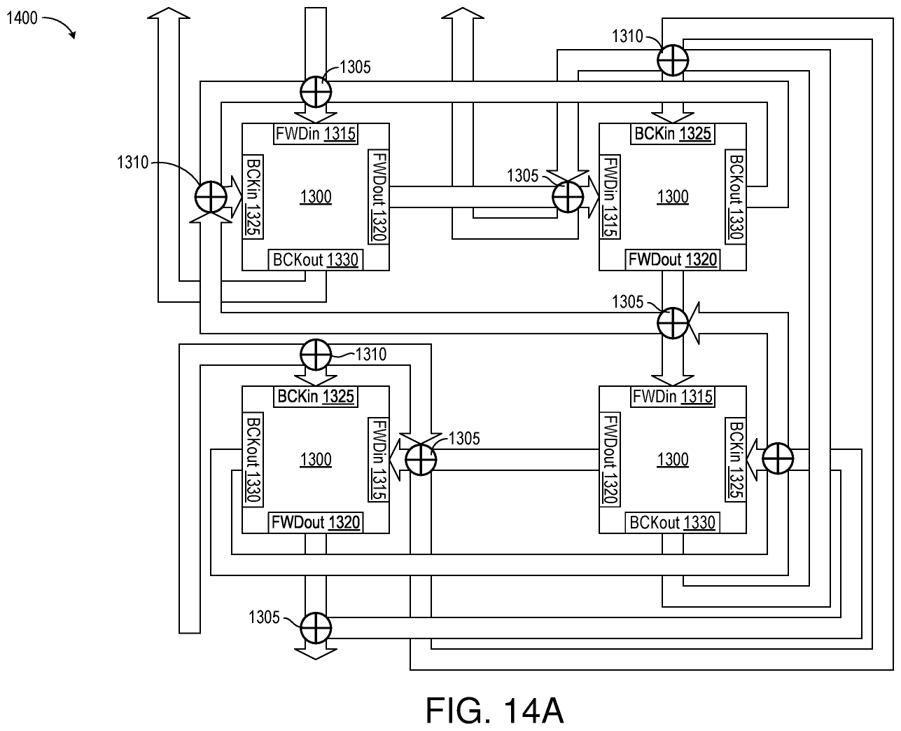

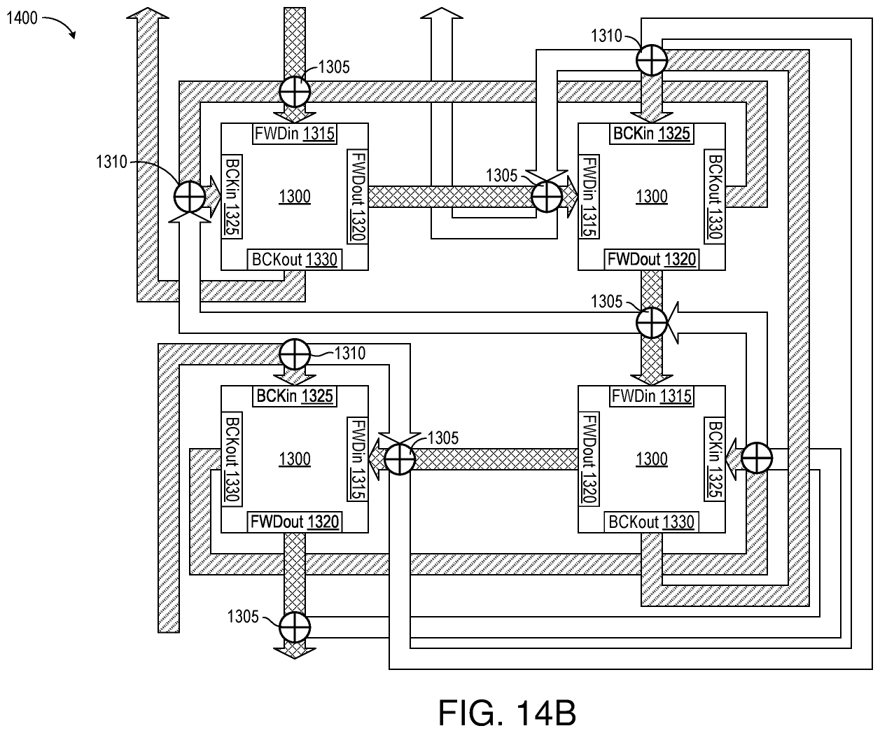

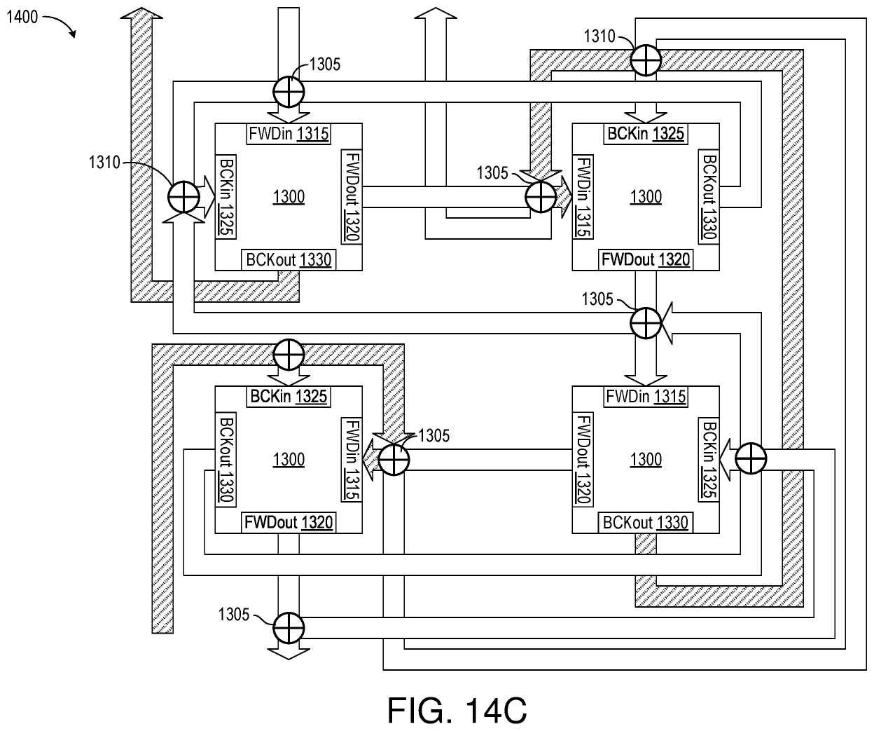

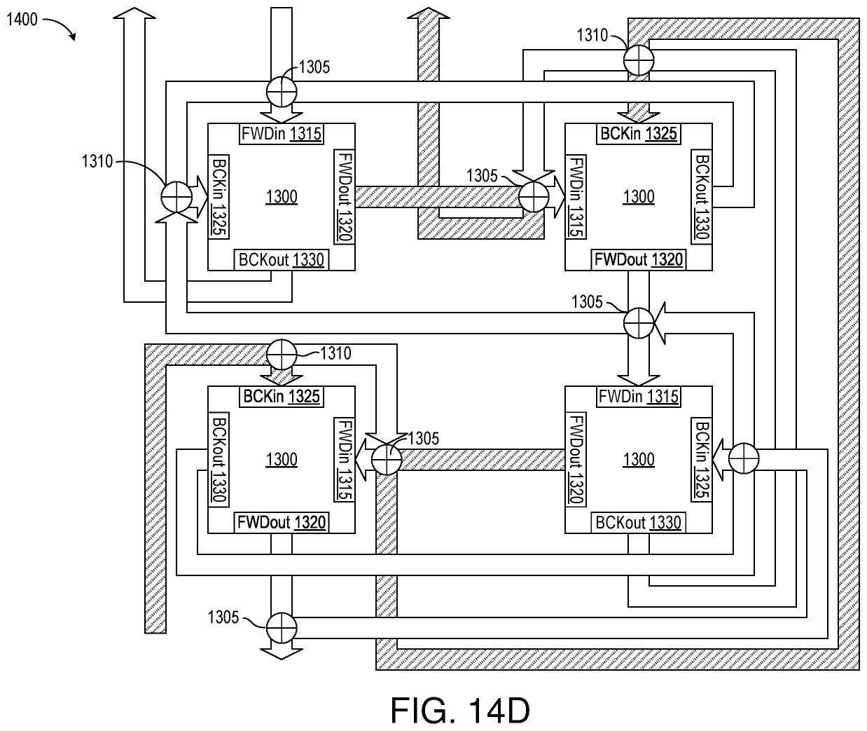

FIGS. 14A-14D depicts a device architecture 1400 in which four processing tiles 1300 can be interconnected by switches 1305 and 1310 to implement a systolic array for a convolutional neural-network, or for a network of processing elements of the type detailed in FIG. 3. Architecture 1400 supports both forward and back propagation, either separately or concurrently. Other embodiments can be limited to convolution, inference, etc. Signal paths between switches and tiles are unidirectional in this example. Architecture 1400 represents paths for filters of an illustrative size and complexity. For larger filters, similar routing and switching can be used to pass data over larger distances (e.g. among more tiles) as needed.

FIG. 14B illustrates how switches 1305 and 1310 can be configured for concurrent forward propagation (inference) and back propagation (adjustment of model parameters). This configuration functions as detailed above in connection with FIG. 2; convolutions are not performed. The forward signal path enters the forward input port 1315 of the upper-left tile 1300 and traverses the remaining downstream tiles in a clockwise direction. The signal paths between that extend to forward input ports 1315 and from forward output ports 1320 are highlighted using a common style of shading. The backward signal path proceeds in the opposite, upstream direction via back-propagation input and output ports 1325 and 1330 along signal paths of common shading. Unshaded signal paths are not used in this mode. Forward and back propagation can proceed separately or concurrently.

FIG. 14C illustrates how switches 1305 and 1310 of architecture 1400 can be configured in a convolutional mode to support the shifting of kernels in the manner illustrated in FIG. 12E. Switches 1305 connect the back-propagation output ports 1330 of some of tiles 1300 to forward-propagation input ports 1315 of neighboring tiles 1300.

FIG. 14D illustrates how switches 1305 and 1310 of architecture 1400 can be configured in another convolutional mode to support the shifting of kernels in the manner illustrated in FIG. 12F. Switches 1305 and 1310 connect the forward-propagation output ports 1320 of some of tiles 1300 to back-propagation input ports 1325 of neighboring tiles 1300.

While the subject matter has been described in connection with specific embodiments, other embodiments are also envisioned. For example, the foregoing embodiments detail relatively spartan tiles and arrays for ease of illustration; the number of arrays and processing elements per array vary widely, and practical neural networks can have many more arrays and many more processing elements per array. Other variations will be evident to those of skill in the art. Therefore, the spirit and scope of the appended claims should not be limited to the foregoing description. Only those claims specifically reciting “means for” or “step for” should be construed in the manner required under the sixth paragraph of 35 U.S.C. § 112.

What is claimed is:

1. An application-specific integrated circuit (ASIC) comprising:
an array of interconnected processing elements, including upstream processing elements and downstream processing elements, each processing element including:
a forward-propagation input port to receive a forward partial result;
a forward-propagation processor to update the forward partial result;
a forward-propagation output port to transmit the updated forward partial result;
a back-propagation input port to receive a back-propagation partial result;
a back-propagation processor to update the back-propagation partial result; and
a back-propagation output port to transmit the updated back-propagation partial result.

2. The ASIC of claim 1, wherein the forward-propagation processor and the back-propagation processor concurrently update the forward partial result and the back-propagation partial result, respectively.

3. The ASIC of claim 1, wherein the forward-propagation output port transmits the updated forward partial result to a downstream one of the processing elements.

4. The ASIC of claim 3, wherein the back-propagation input port receives the back-propagation partial result from the downstream one of the processing elements.

5. The ASIC of claim 1, wherein each of the forward-propagation input port and the back-propagation input port are unidirectional.

6. The ASIC of claim 1, further comprising first storage to store the forward partial result and second storage to store the back-propagation partial result.

7. The ASIC of claim 1, further comprising memory to store a weight for each of the processing elements, the forward-propagation processor to update the forward partial result as a function of the weight.

8. The ASIC of claim 7, wherein the back-propagation processor in each of the processing elements is coupled to the memory to update the weight.

9. The ASIC of claim 7, wherein the array of interconnected processing elements occupies a first die in a stack of dies and the memory occupies a second die in the stack of dies.

10. The ASIC of claim 9, wherein the memory is coupled to the first die by conductive vias.

11. The ASIC of claim 10, wherein the conductive vias are through-silicon vias.

12. The ASIC of claim 1, further comprising an activation-function processing element coupled to a last of the downstream processing elements to apply an activation function to a last of the forward partial results.

13. The ASIC of claim 12, further comprising a second array of interconnected processing elements, including a second processing element coupled to the activation-function processing element to receive the last of the forward partial results with the applied activation function.

14. An application-specific integrated circuit (ASIC) comprising:
an array of interconnected processing tiles, including upstream processing tiles and downstream processing tiles, each processing tile including:
a forward-propagation input port to receive input data from an upstream processing tile;
processing elements to collectively compute a partial result as a function of the input data from the upstream processing tile;
a forward-propagation output port to convey the partial result to a downstream processing tile; and
a back-propagation output port; and
forward-propagation input switches, each of the forward-propagation input switches coupled to the forward-propagation input port of a first of the processing tiles, the forward-propagation output port of a second of the processing tiles upstream from the first of the processing tiles, and the back-propagation output port of a third of the processing tiles downstream from the first of the processing tiles.

15. The ASIC of claim 14, each of the forward-propagation input switches to alternatively route the partial result from the forward-propagation output port of the second of the processing tiles or a back-propagation partial result from the back-propagation output port of the third of the processing tiles to the forward-propagation input port of the first of the processing tiles.

16. The ASIC of claim 14, each of the forward-propagation input switch to concurrently route:
the partial result from the forward-propagation output port of the second of the processing tiles to the forward-propagation input port of the first of the processing tiles; and
signals from the back-propagation output port of the third of the processing tiles downstream from the first of the processing tiles past the forward-propagation input port of the first of the processing tiles.

17. The ASIC of claim 14, wherein the array of interconnected processing tiles is instantiated on a base layer of a stack of integrated-circuit dies, the stack including memory dies.

18. The ASIC of claim 17, wherein the memory dies include vaults to store partial results.

19. The ASIC of claim 14, wherein the array of interconnected processing tiles and forward-propagation input switches support nested loops, including a multiply-accumulate loop and a kernel-stride loop.

20. The ASIC of claim 19, wherein the array of interconnected processing tiles and forward-propagation input switches further supports a second kernel-stride loop orthogonal to the first kernel-stride loop.
